(19) United States
(12) Patent Application Publication
(10) Pub. No.: US 2005/0240578 A1
(43) Pub. Date: Oct. 27, 2005

(54) Litigation management system and method of providing the same

(75) Inventors: Daniel J. Biederman SR., Downers Grove, IL (US); Thomas X. Hoban, Chicago, IL (US); David F. Craigmile JR., Chicago, IL (US); Clarissa R. Quimson, Chicago, IL (US)

Correspondence Address: Breiner & Breiner, L.L.C., P.O. Box 19290, Alexandria, VA, 22320-0290, US

(73) Assignee: CASEKNOWLEDGE, L.L.C., Chicago, IL (US)

(21) Appl. No.: 11/109,722

(22) Filed: Apr. 20, 2005

Related U.S. Application Data
(60) Provisional application No. 60/565,514, filed on Apr. 27, 2004.

(51) Int. Cl. G06F 17/30

(52) U.S. Cl. 707/3

(57) ABSTRACT

A web-based litigation management system and method which enables users, e.g., lawyers and clients, to monitor and manage at least one lawsuit in a litigation portfolio, manage the performance and expenses of the at least one lawsuit and compile controls/metrics that may be utilized in evaluating and streamlining future litigation is disclosed. Monitoring of a lawsuit is achieved via the entry and update of actual results, actions and events which occur throughout the litigation process. The litigation management system also allows users to: compare budgeted results, actions and expenses with actual results, actions and expenses; monitor and review legal documents; calculate litigation controls/metrics; compare the results of pre-selected lawsuit portfolios and the performance of the individuals involved in those lawsuits; document litigation guidelines as required by the client and the lawyer's theory of the case, and provide easy data entry and browsing and searching of documents.

### RELATED APPLICATIONS

This application hereby claims the benefit under 35 U.S.C. § 119(e) of U.S. Provisional Application Ser. No. 60/565,514, filed Apr. 27, 2004, entitled LITIGATION MANAGEMENT SYSTEM AND METHOD OF PROVIDING THE SAME.

### FIELD OF INVENTION

The invention is directed to a web-based litigation management system and method of providing the same. More particularly, the invention is directed to a litigation management system and method of monitoring and managing a litigation portfolio via the Internet. The litigation management system and method of providing a litigation management system of the present invention enables users, such as lawyers and clients, to monitor at least one lawsuit in a litigation portfolio, manage the performance and expenses of the at least one lawsuit in a litigation portfolio and compile metrics that may be utilized in evaluating and streamlining future litigation.

### BACKGROUND OF THE INVENTION

For years, many products and methods have been developed to assist the legal profession in the management of litigation and litigation dockets. However, many of these products and methods are targeted largely to law firms and lawyers and concentrate their main function on managing individual cases. Many of these products and methods are similar to organizers since they have a calendar, task list and contact management capabilities. Additionally, these products and methods may track information which would be found in a lawyer's files. However, these products and methods are not targeted specifically to the needs of the client, especially when the client is an insurance company or in the insurance industry.

Many of the prior art products and methods relating to litigation case management are largely extensions of generic document management products for a wide array of industries and provide only minimal adaptation to suit the needs of the legal profession. While many of these products and methods are strong in the document management area, most of them do not provide process control and portfolio monitoring and managing features.

Many prior art litigation case management products and methods do not provide clients with timely and consistent information regarding the status and exposure of pending cases. Additionally, as the litigation proceeds, clients receive a copy for their records of the various documents which are filed, exchanged, etc. throughout the litigation. These large volumes of litigation documents are difficult and expensive for clients to manage and maintain.

In monitoring and managing a litigation portfolio, clients, including insurance companies, have traditionally managed their litigation portfolios through a manual, ad hoc and largely paper-based system that becomes inefficient as the caseload increases. For example, claims adjusters within insurance companies manage a significant number of cases at a time. By using prior art products and methods of litigation management, it becomes increasingly difficult for these claims adjusters to manage the requirements of each lawsuit, as well as to oversee the work of the lawyers that are actually defending the lawsuits.

Known in the art is Heckman et al., U.S. Pat. No. 5,875,431, which is said to disclose a computer-based, closed-loop legal strategic planning control system and method having interactive convergence to an optimal strategy and dynamic tracking of current prevailing legal climates.

The litigation management system and method of the present invention provides a litigation management system and method of monitoring and managing litigation portfolios which addresses the shortcomings and problems of previous litigation management products and methods.

### SUMMARY OF THE INVENTION

The invention is directed to a web-based litigation management system and method of providing the same. More particularly, the invention is directed to a litigation management system and method of providing a litigation management system which allows a user to monitor and manage at least one assigned lawsuit in a litigation portfolio in the litigation management system via the Internet. This web-based litigation management system allows a user to supplement or even replace traditional manual, paper-based systems for managing litigation portfolios.

The litigation management system and method of providing a litigation management system of the present invention enables users, i.e., lawyers and clients, to monitor at least one lawsuit in a litigation portfolio, manage the performance and expenses of the at least one lawsuit in the litigation portfolio and compile metrics, i.e., information that may assist in controlling expense and exposure, that may be utilized in evaluating and streamlining future litigation. The monitoring of the at least one lawsuit in a litigation portfolio is achieved via the entry and update of actual results, actions and events which occur throughout the litigation process. The litigation management system may also allow a user to compare budgeted results and actions such as expenses with actual results and actions and to monitor and review legal documents. The metrics of the litigation management system are calculated and stored in searchable databases which allow a user to compare the results of pre-selected lawsuits in a litigation portfolio and the performance of the individuals involved in these lawsuits. The litigation management system provides case management by the documentation of litigation guidelines as required by the lawyer's theory of the case and the client's objectives. The litigation management system also provides ease of data entry and browsing and searching of documents.

The litigation management system assists in the management of litigation claims by: prescribing litigation practice standards; providing a system of controls designed around the practice standards to ensure that the prescribed standards are properly and timely accomplished; supplying litigation metrics, and digitally managing an entire litigation file and making all file materials searchable from a secure repository. The present web-based litigation management system provides real time access to, but not limited to, the case status, the documents, the performance metrics and the process workflow for the at least one lawsuit in the litigation portfolio.

The litigation management system and method of providing a litigation management system of the present invention primarily addresses and supports the needs of the insurance industry, corporations and their counsel. Primary users may include claims adjusters in an insurance company, general counsel and in-house lawyers who manage the litigation portfolios in corporations, and insurance defense lawyers. However, the web-based litigation management system and method of providing a web-based litigation management system of the present invention may be utilized to manage a litigation portfolio by any suitable end user, i.e., client and corresponding counsel, that has access to an Internet connection. The end user may also retain documents and monitor alerts and updates throughout the litigation process via the litigation management system and method of the invention.

A primary object of the invention is to provide a web-based litigation management system and method which utilizes a systematic and disciplined approach to managing litigation portfolios by adhering to established litigation guidelines and monitoring processes.

A primary object of the invention is to provide a web-based litigation management system and method which utilizes an alert system that notifies lawyers and/or clients of various deadlines, due dates and upcoming events.

A primary object of the invention is to provide a web-based litigation management system and method which utilizes a template for: developing a case strategy, status reports, a case budget and reserve requirement; tracking financial performance and expenses versus budgeted expenses, and providing a summary of required expenses.

An object of the invention is to provide a web-based litigation management system and method that provides document management capabilities including, but not limited to, scanning and digitally managing documents related to pre-selected litigation portfolios.

An object of the invention is to provide a web-based litigation management system which includes specific metrics which enable clients to compare performance of various legal resources with respect to the results of various actions including, but not limited to, valuing settlements, forecasting potential settlement values, accelerating resolution of lawsuits, allowing a client to determine the most effective litigation strategy and re-engineering the litigation strategy throughout the litigation process.

An object of the invention is to provide a web-based litigation management system that is easy for the user to understand and patterned after the litigation process lawyers follow when trying a case.

### DETAILED DESCRIPTION OF THE PREFERRED EMBODIMENTS

The invention is directed to a web-based litigation management system and method of providing the same. More particularly, the invention is directed to a litigation management system and method of providing a litigation management system which allows a user to monitor and manage at least one assigned lawsuit in a litigation portfolio in the litigation management system via the Internet. This web-based litigation management system allows a user to supplement or even replace traditional manual, paper-based systems for managing litigation portfolios.

The litigation management system and method of providing a litigation management system of the present invention enables users, i.e., lawyers and clients, to monitor at least one lawsuit in a litigation portfolio, manage the performance and expenses of the at least one lawsuit in the litigation portfolio and compile metrics that may be utilized in evaluating and streamlining future litigation. The monitoring of the at least one lawsuit in a litigation portfolio is achieved via the entry and update of actual results, actions and events which occur throughout the litigation process. The litigation management system may also allow users to compare budgeted results and actions such as expenses with actual results and actions and to monitor and review legal documents. The metrics of the litigation management system are calculated and stored in searchable databases which allow users to compare the results of pre-selected lawsuits in a litigation portfolio and the performance of the individuals involved in these lawsuits. The litigation management system provides case management by the documentation of litigation guidelines as required by the lawyer's theory of the case and the client's objectives. The litigation management system also provides ease of data entry and browsing and searching of documents.

The litigation management system assists the user in the management of litigation claims by: prescribing litigation practice standards; providing a system of controls designed around the practice standards to ensure that the prescribed standards are properly and timely accomplished; supplying litigation metrics, and digitally managing an entire litigation file, making all file materials searchable from a secure repository. The web-based litigation management system also preferably provides real time access to, but not limited to, the case status, the documents, the performance metrics and the process workflow for the at least one assigned lawsuit in a user's litigation portfolio.

The litigation management system and method of the present invention is commenced by a lawsuit being assigned to the litigation management system by a lawyer or client making an assignment request or by any appropriate manner. Once assigned, the end users, i.e., the client and corresponding lawyers involved in the lawsuit, are given a pre-selected user name and password to access their at least one lawsuit assigned to the litigation management system.

Lawyers and clients may access their at least one lawsuit in the web-based litigation management system by going to a selected website on the Internet. In a preferred embodiment, the website homepage includes a plurality of fields, including, but not limited to, Login/Logout, My Cases, My Calendar, Alerts, Password Management and Administration. The user will select the Login/Logout field and then enter the user name and password in order to gain access to the user's homepage which contains the user's litigation portfolio in the litigation management system. The user's homepage is preferably entitled My Cases for clients and lawyers and entitled Administration for administrators for the litigation management system, clients and law firms.

Once a lawsuit is assigned to the litigation management system, appropriate litigation guidelines are developed in accordance with the requirements of the litigation and the client. The guidelines are litigation templates that capture important information regarding certain aspects of each case. The templates assist in providing consistent information in all cases. The templates also reduce administrative time expended by a lawyer reporting to a client upon the happenings of the case. The litigation guideline templates preferably include, but are not limited to, (1) an initial status report; (2) jury instructions; (3) a living theory of the case; (4) a litigation plan; (5) a litigation budget; (6) a settlement analysis; (7) experts; (8) activity status reports; (9) an anticipated trial date; (10) contacts; (11) billing guidelines and (12) controls/metrics. While these templates in a preferred embodiment of the invention are detailed below, the templates may be modified or substituted for any suitable templates.

Prior to completing any litigation guideline templates and within a certain time period, preferably within 48 hours of the initial assignment of the case to the litigation management system, the lawyer is to complete a conflict analysis. Any actual or potential conflicts are to be discussed with the client at the time of the engagement or as soon as the conflict becomes known.

A draft answer or other responsive pleading to the complaint may be posted to the litigation management system within a certain time period prior to its due date, preferably within 7 to 10 days prior to its due date. The client may then review the draft answer or responsive pleading in the litigation management system. Upon approval by the client, counsel is expected to timely file the answer or responsive pleading. At this point, counsel is also expected to take all necessary steps to avoid technical defaults and to ensure that service is proper.

The preferred litigation guideline templates are then to be completed and posted to the appropriate lawsuit in the user's litigation portfolio in the litigation management system as appropriate and as detailed hereafter.

Initial Status Report

Within a certain time period, preferably within 60 days of the assignment of the litigation to the litigation management system, an initial status report shall be posted on the litigation management system. The initial status report may include the details surrounding the investigation conducted to understand the facts giving rise to the litigation. This investigation shall be performed as soon as reasonably possible.

In a preferred embodiment, an initial status report may include, but is not limited to, the date; the synopsis of the case; the facts giving rise to the cause of action; the description of injuries or claimed damages and/or the summary of the initial investigation.

Jury Instructions

Within a certain time period, preferably within 90 days of the initial case assignment, the lawyer may identify and post to the litigation portfolio in the litigation management system the substantive jury instructions for the case. Identifying, developing and reviewing the relevant jury instructions at the outset of the case allows the lawyer to focus on the law of the case and assists in the preparation of the litigation plan.

Living Theory of the Case

A living theory of the case may be posted to the litigation portfolio in the litigation management system within a certain time period, preferably within 90 days of the initial assignment of the case. Developing a theory of the case early in the litigation and revising that theory as additional information is obtained throughout discovery is critical to a successful litigation. The living theory of the case directs the lawyer in what must be accomplished in order to succeed in the litigation. The lawyer must continually reevaluate the theory of the case as the case develops. The discipline of preparing and continually reexamining the living theory of the case assists the lawyer in understanding the importance of each piece of evidence obtained during discovery. This discipline also focuses the lawyer's attention on the evidence that is in dispute. The lawyer's ability to explain why the evidence is in dispute will aid the lawyer in succeeding at trial since a well developed, cohesive, logical theory offers the jury a possible explanation of what event really occurred to give rise to the lawsuit.

In a preferred embodiment, a template for the living theory of the case may include, but is not limited to, the date; the synopsis of case; the living theory of the case; the facts relating to the theory including supporting facts and inconsistent facts, and specific facts to be further investigated.

Litigation Plan

A litigation plan may be posted to the litigation management system within a certain time period, preferably within 90 days of the initial assignment of the case. In developing the litigation plan, the lawyer is preferably required to perform, but is not limited to, the following analysis:

(1) Review the legal elements of each cause of action pled in the case;

(2) Identify the facts/evidence that must be obtained in discovery in order to prove each of the required elements;

(3) Identify witnesses who are able to provide the necessary foundation for the facts/evidence needed;

(4) Identify what facts/evidence will be disputed and identify the witnesses and evidence to be used in putting those facts at issue;

(5) Evaluate evidentiary issues in order to maximize the admissibility of the proof; and

(6) Consider admissible evidence possessed by each party to determine both sides' strengths and weaknesses.

A template for the litigation plan may include, but is not limited to, the date; the case title; the case number; the synopsis of the case; the legal elements of the claims, counter claims, cross claims and/or affirmative defenses pled; the identification of the evidence and witnesses who will establish the foundation for the evidence; the evidentiary considerations; the description of the litigation strategy; the litigation activities/tasks including the estimated completion date; the experts including the date to disclose opinion witnesses; the anticipated outcome of the identified activities, and the current evaluation of liability, defenses, contribution, etc.

Each document in the case may be completed by the lawyer and posted to the litigation plan section of the litigation management system. The documents will be immediately available for review by the client. The completion of the strategic litigation documents focuses the lawyer's attention on the substantive issues of the case and ensures that the discovery conducted by the lawyer has a specified purpose.

Litigation Budget

Litigation success also depends on accountability. Within a certain time period, preferably within 90 days of the initial assignment of the case, the lawyer may post a complete litigation budget to the litigation portfolio in the litigation management system. Once the budget is approved by the client, the initial budget will be maintained within the litigation management system and compared to the final/actual litigation expenses.

Settlement Analysis

Within a certain time period, preferably within 90 days of the initial assignment of the case, the lawyer is responsible for completing the settlement analysis within the litigation management system. The lawyer is also responsible for including settlement recommendations, as well as documenting the history of settlement discussions in the settlement analysis. Immediate and continued efforts should be made to identify cases for early disposition, as well as cases that could be handled more effectively through mediation, arbitration or other means of alternative dispute resolution. The lawyer is responsible for ensuring at all times that the settlement analysis is consistent with information contained in correspondence to the client. All correspondence to the client relating to the settlement analysis should be maintained in the settlement analysis section of the litigation management system.

Experts

At the outset of a litigation, it is vitally important that the lawyer inform the client of the need for opinion/expert testimony, if necessary. It is also important that the lawyer indicate in the litigation plan the date that experts must be identified. Once it is determined that an opinion/expert witness is needed, the lawyer may post in the litigation portfolio in the litigation management system a Curriculum Vitae for experts that the lawyer recommends. For the experts posted in the litigation management system, the lawyer should include, but is not limited to, a narrative about the experts, as well as information regarding costs, i.e., hourly fees, additional fees/costs, etc.

Activity Status Report

An activity status report should be completed by the lawyer whenever a significant event occurs in the litigation process. The event may be, but is not limited to, the receipt of important information obtained from documents received in discovery, information received during a deposition, a court order and/or discussions with other lawyers. In a preferred embodiment, the lawyer should include within the activity status report information regarding the effect on the evaluation of the case, the effect on the litigation plan and any additional work necessary in response to the event. The activity status reports also document the changes that have occurred in the living theory of the case and the litigation plan. Additionally, any request for changes to the litigation budget should be documented and explained in an activity status report.

In a preferred embodiment, the template for an activity status report may include, but is not limited to, the date; the synopsis of the case; the identification of the activity/task/event; the summary of significant information regarding the activity/task/event; the effect on the evaluation of the case; the effect on the litigation plan, and any additional work necessary in response to the activity/task/event.

Anticipated Trial Date

Every case should include an anticipated trial date, even if that date is simply an estimate. The trial date is important within the litigation management system because the trial date and the estimate of exposure are used to determined future cash needs and the litigation plan. The lawyer is responsible for updating the litigation management system with the actual trial date once known. The trial date is to be posted in the litigation portfolio in the litigation management system for each case.

Contacts

The lawyer is responsible for maintaining current information on the contacts page for each case in the litigation management system. The lawyer may also include all lawyers assigned to the case.

Billing Guidelines

Within a predetermined time period, preferably within 90 days of the initial case assignment, a complete litigation budget should be posted to the litigation management system for each case. Each month, the lawyer is responsible for updating the budget. In a preferred embodiment, if additional hours are needed for any particular line item category, the lawyer shall include the estimate of additional hours and submit the request for approval. The explanation for additional hours may be included in the billing guidelines and an activity status report. The litigation management system of the present invention requires detailed monthly bills. The bills should include, but are not limited to, the name of the lawyer handling the matter, the date of the service, the time allocated to the service and a full description of the service rendered.

Controls/Metrics

The litigation management system of the present invention provides a comprehensive system of internal controls/metrics which monitor important objectives, tasks and events so that important dates are not missed. An example of this internal control is monitoring various due dates, such as the dates for disclosing an expert's opinion. Other controls/metrics that may be tracked by the litigation management system of the present invention include, but are not limited to, the status of the case, the case outcome, the performance of the lawyer, the performance of a particular law firm, the results from a particular jurisdiction, and/or future expenses associated with the litigation. This information may be communicated to the lawyer or client by various methods including, but not limited to, e-mail and/or periodic management reports.

The litigation management system and method of the present invention provides various quality controls and results to the end users. These quality controls and results may preferably include monitoring: the timely completion/posting of a draft answer or responsive pleading; the substantive jury instructions; the initial status report; the living theory of the case; the litigation plan; the litigation budget; the calculation of exposure and settlement; the expert report, and the pleadings/motions and corresponding deadlines posted to the litigation management system.

Additional quality controls and results may also preferably include monitoring the jury trial. Monitoring the jury trial preferably includes controls and results for preparation of witnesses, sufficiency of motions in limine, opening statement, ability to handle objections, direct examination, cross-examination, sequence of witnesses, ability to handle demonstrative evidence, ability to lay a proper foundation, ability to communicate the theory of the case, closing argument, and/or interview with the jurors.

Quality controls and results surrounding settlement issues may include, but are not limited to, calculating settlement parameters, communicating settlement parameters, obtaining authority for settlement, and the timing of settlement. Quality controls and results of the litigation management system surrounding cost and efficiency may include the budget versus actual legal expense, the budget versus actual exposure, the number of times a lawyer/law firm exceeded the budget, the average verdict per lawyer/law firm, the average value of settlement per lawyer/law firm, the average cost for discovery for all cases handled by a lawyer/law firm, the average cost of trial for all cases handled by a lawyer/law firm, the average number of depositions taken in a particular case, the number of times a lawyer/law firm requested an extension of time for responding to a motion, discovery, and/or trial, and various staffing matters.

The litigation management system and method of the present invention provides lawyers and clients with consistent information regarding the status of the case and financial information, both expense and exposure, for each case, as well as for the entire portfolio of cases for the client. The future cost to defend a case, as well as the financial exposure presented by each case, may be provided in a management summary for the client. Case requirements are based upon the time cases are predicted to go to trial. Clients are also provided with a summary of information concerning resolved cases. Resolved case information enables the litigation management system to rank a lawyer's performance. In a preferred embodiment, an objective rating range, such as from 0 to 10, may be calculated for each case based upon objective financial goals. The litigation management system ranking of lawyers and law firms allows clients to assign future cases to the most productive and efficient lawyers and/or firms.

Throughout the litigation process, lawyers communicate with their clients through written correspondence in order to provide a permanent record of the advice that was provided. Lawyers also generate numerous documents throughout the course of the discovery process and the litigation process that require the client's review and comment. The client's review of such documents is often important for the lawyer in handling the case to gain a proper insight of the facts relating to the case. Successful litigation depends on effective collaboration between a lawyer and client. The litigation management system and method of the present invention reduces and/or eliminates the inefficiency of current litigation case management where duplicate litigation files are maintained, one file by the lawyer and one by the client. Various expenses associated with copying documents received from third parties and forwarding these copies to clients, as well as preparation of draft documents for the client's review may be reduced through the litigation management system of the present invention.

The litigation management system also provides digital, secure management of an entire litigation file which is accessible by the client any time, worldwide. In a preferred embodiment, the litigation management system provides browser-based, secure web access to a client's entire litigation portfolio. The client no longer has to maintain a duplicate file, spending time organizing its file or wasting time looking for misfiled documents. The litigation management system provides immediate and easy access via the Internet to any document in the client's litigation portfolio. Documents relating to a file are simply posted by the lawyer to the litigation management system and are immediately available for client review. This eliminates the need to fax, mail, or overnight documents to the client.

The litigation management system focuses on communication and collaboration between the lawyer and the client. The information and documents in the litigation management system can be accessed immediately once the lawyer posts the information to the site and can be viewed by both the client and the lawyer. The contents of each litigation portfolio are preferably organized in a traditional familiar format facilitating the retrieval of file information.

In a preferred embodiment, the litigation management system and method of the present invention primarily addresses and supports the needs of the insurance industry, corporations and their counsel. Primary users may include claims adjusters in an insurance company, general counsel and in-house lawyers who manage the litigation portfolios in corporations, and insurance defense lawyers. However, the web-based litigation management system and method of providing a web-based litigation management system of the present invention may be utilized by any suitable end user, i.e., client and corresponding counsel, which has access to an Internet connection. The user may also retain documents, and monitor alerts and updates throughout the litigation process via the litigation management system and method of the invention.

In a preferred embodiment, the litigation management system and method of the present invention contains the following preferred options, including but not limited to the following: menus, administrative screens, and case management options. As described above, the litigation management system's website homepage preferably contains the following field options including, but are not limited to, My Cases, My Calendar, Login/Logout, Alerts, Password Management, and Administration. The My Cases screen enables a user to view all cases associated with the user. The My Cases screen also displays current alerts to the user. The My Calendar field option enables the user to view his calendar. The Login/Logout field option enables a user to log into and out of the litigation management system as described above. The Alerts field option allows a user to view and manage various alerts relating to the at least one lawsuit in his litigation portfolio. The Password Management field option allows a user to change his password to the litigation management system. The Administration field option provides a user with various administration options including, but not limited to, client management, law firm management, user management, document attributes management and manage company locations.

The field options listed above, as well as other field options, are described in greater detail hereafter.

The Alerts field option allows a user to view and manage his alerts. Specifically, the Alerts field option provides a user with a list of alerts ordered by priority and date in the at least one lawsuit in his litigation portfolio. Upon viewing an alert, a user may respond to an alert. The litigation management system preferably indicates when an alert has been viewed and/or responded to. A user may create a new alert in the at least one lawsuit in his litigation portfolio by preferably entering an alert and clicking a submit button. For new alerts, the litigation management system may preferably store an alert code value which has been defined by the user for the alert.

In a preferred embodiment, various events may generate an alert for a user. These events include, but are not limited to, a discovered conflict; a draft answer or responsive pleading not posted within the specified time period; a file stamped answer and/or responsive pleading not posted within the specified time period; the litigation budget not completed; jury instructions not assigned; living theory of the case not posted; litigation plan not posted; settlement analysis not posted; living theory of the case modified; litigation plan modified; budget modified; activity status reports posted; any discovery posted; any discovery response not posted; and any addition, modification or deletion to the litigation calendar of events.

In a preferred embodiment, the My Cases field option screen provides a user with a list of all pending and resolved cases that the user has access to, i.e., cases in the user's litigation portfolio. The My Cases field option screen may also display any alerts to the user. The My Cases field option screen also allows a user to access details of the at least one lawsuit in its litigation portfolio by preferably clicking on the case name. The My Cases field option screen may also provide the user with the following field options, but are not limited to, pending case headers and case lists, pending case totals, resolved case headers and line items, and alerts list.

The My Calendar field option screen provides a user with a simple linear listing of dates for events and appointments in his schedule or in the litigation. A user may view the entries in the My Calendar field option by day, week, and/or month. Each user may view, create, and/or edit an entry listed in his My Appointment field option screen.

The following is a detailed description of the various field options available under the Administration field option. The client management field option screen allows administrators of the litigation management system to view and manage clients. The administrator may preferably use this field option to list all clients in the litigation management system and to add, delete, modify, and/or disable/enable client entries in the litigation management system.

The law firm management field option enables administrators of the litigation management system to add and manage law firms that use the system. Preferably, the law firm management field option allows administrators to view and list all law firms in the litigation management system and to add, delete, modify, and/or enable/disable a law firm entry. An administrator of the litigation management system may also use a new company screen field option to edit and/or create a new company entry, i.e., a new law firm and/or client entry.

In the client management, law firm management, and/or new company field options, an administrator of the litigation management system may add, edit, or delete any suitable information regarding the client or law firm. Each client, lawyer and/or law firm may also add, modify, or delete entries in its own litigation portfolio.

A document attributes management field option screen may allow an administrator of the litigation management system to monitor and/or manage customer document attributes, which are client specific meta-data fields that appear in each litigation portfolio in the litigation management system. An administrator may preferably edit, add, delete, and/or save various attributes in a selected litigation portfolio.

The user management field option screen preferably allows litigation management system administrators, law firm administrators and/or client administrators to manage and monitor their respective individual users of the litigation management system. Each administrator may view, list, add, modify, disable/enable, and/or delete a respective end user to his at least one lawsuit in his litigation portfolio. Each administrator may also create, edit, and manage his respective users and the various entries in his at least one lawsuit in his litigation portfolio in the litigation management system.

Other field option screens that may be available to a user in a preferred embodiment of the litigation management system and method of the present invention are as described hereafter.

A lawyer details field option screen may be used to add lawyer specific data for a user. This data may include, but is not limited to the following information regarding a lawyer: area of practice, jurisdiction, biography, experience, and any other suitable data. A manage company locations field option screen may be used to manage locations for clients, lawyers and law firms. Various information including, but not limited to, the location, address, administrator, and any other suitable information relating to the client, lawyer and/or law firm may be added, deleted, and/or edited in this field option by an appropriate user. A panel administration field option screen may be used by a client to view his law panel and to add or edit law firms and/or lawyers on his panel. This field option screen allows a client administrator to view all firms and lawyers registered in a litigation management system. The law firms and lawyers are preferably organized by geographical location of the firm offices and lawyer office locations. By viewing this list, a client administrator may add, disable and/or modify a law firm and/or lawyer listing on his law panel. Any suitable data about the law firms and/or lawyers may be contained in this field option.

A case administration field option screen provides a user with various field options with respect to the various aspects of the at least one lawsuit in his litigation portfolio. The following case administration field options may also be contained in the My Cases field option for each client and may be viewed, added, edited, and/or deleted by an authorized user. The case administration field options include, but are not limited to, time entry; alerts; case management including case properties, notes, contacts, correspondence, litigation timeline, chronology of events, law firm personnel, and invoices; documents; court documents including pleadings, motions, and/or court orders; case status/case strategy including initial status, activities status, settlement analysis, jury instructions, litigation budget, litigation plan, living theory of the case, and research; written discovery including document production requests, subpoenas for documents, interrogatories, requests to admit, and review of written discovery; oral discovery including deposition summaries, witnesses, depositions and subpoenas for testimony; expert discovery including expert Curriculum Vitae, outline of opinions, recommendation of experts, and expert reports; pre-trial/trial including exhibits, trial witnesses, motions in limine, and a pre-trial memoranda; and client guidelines including code of conduct and litigation guidelines.

Any suitable data and information may be viewed, added, modified, and/or deleted in any of the various field options listed above by any suitable and authorized user.

While the preferred field options, field option names, and information contained in each field option of the preferred embodiment of the present invention have been described herein, any suitable field option, field option name and corresponding field option information may be utilized in accordance with the litigation management system and method of the present invention and fall within the scope of the description above. Revision of field options, field option requirements, and/or field option data and information relating to the litigation management system and corresponding litigation portfolios are apparent and also fall within the scope of the description above.

The following is an example which is intended to illustrate the invention and not to limit the invention. The example illustrates a situation where the invention may be used by a lawyer and a client, such as a claims adjuster in an insurance company, to monitor and manage the events and actions of a lawsuit in which the client is a party and wherein various results are obtained. This example illustrates one of the many ways that the invention may be used.

Initially, the lawsuit must be assigned to the litigation management system and all of the details regarding the case must be entered into the litigation management system. While a lawsuit may be assigned to the litigation management system at any time throughout the litigation process, the lawyer had this case assigned to the litigation management system immediately after the client was served with the complaint. Then, the client and his lawyers received a user name and password in order to access the lawsuit in a litigation portfolio on the litigation management system.

In this lawsuit, the complaint was just served and an answer needs to be filed. In preparing to file an answer to the complaint, the lawyer must prepare a draft answer. Once the draft answer is completed by the lawyer, it must be reviewed by the client. In using the present invention, the lawyer goes to a selected website for the litigation management system and enters his user name and password. The lawyer may then post the draft answer to this lawsuit in the litigation portfolio in the litigation management system. Once the draft answer is posted, the client goes to the selected website and enters his user name and password. The client may immediately view the draft answer and provide his comments to the lawyer. With the litigation management system, the client does not have to wait for the draft answer to arrive, such as by mail. The client may immediately access and review the draft answer and post his comments. The lawyer may immediately access and review the client's comments and does not have wait for the client's comments to arrive, such as by mail. Additionally, the client and lawyer may continually view and modify the draft answer and comments thereto posted in the litigation management system. Once the lawyer receives the client's final comments, he may file the answer by the due date.

If the lawyer does not post his draft answer within a predetermined time before its due date, the litigation management system will provide an alert indicating that the draft answer is past due to be posted for review by the client. In the same manner, if the client does not post his comments to the draft answer within a predetermined time, the litigation management system will provide an alert indicating that the comments to the draft answer are past due to be posted.

The litigation management system may be used in the same manner by the client and lawyer for any aspect of the lawsuit. The client and lawyer may also review any document filed or exchanged in the lawsuit without having to spend time looking through file drawers for the correct file. All the client or lawyer has to do is go to the website, enter his user name and password and select the field options which allow a user to view any desired document in a lawsuit in his litigation portfolio in the litigation management system.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

1. A method of providing a web-based litigation management system comprising:
(a) receiving an assignment request for a lawsuit by at least one user;
(b) reviewing said request and initiating a litigation portfolio for said lawsuit;
(c) receiving information concerning events, actions or details of said lawsuit from said at least one user;
(d) posting said information concerning events, actions or details of said lawsuit to said litigation portfolio; and
(e) providing at least one output result to said at least one user, wherein said output result includes at least one: litigation practice standard; system control; system alert; litigation metrics; litigation file management action; searchable litigation materials, and/or real time access to case status, documents, performance metrics, and/or litigation process workflow.

2. The method according to claim 1, further comprising repeating (c) through (e) until said at least one user receives at least one pre-determined result.

3. The method according to claim 1, wherein said at least one user accesses said at least one output result through a predetermined website, wherein a home page of said website includes a plurality of fields.

4. The method according to claim 3, wherein said plurality of fields include at least one of Log In/Log Out, My Cases, My Calendar, Alerts, Password Management, or Administration.

5. The method according to claim 4, wherein said at least one user selects said Log In/Log Out field and enters a user name and password to gain access to said litigation portfolio.

6. The method according to claim 1, further comprising developing litigation guidelines which are litigation templates that capture information regarding various aspects of each litigation.

7. The method according to claim 6, wherein said litigation guideline templates include at least one of an initial status report, jury instructions, a living theory of a case, a litigation plan, a litigation budget, a settlement analysis, experts, activity status reports, anticipated trial date, contacts, billing guidelines and controls/metrics.

8. The method according to claim 1, wherein posting said information includes posting draft documents, draft pleadings, or pleadings.

9. The method according to claim 7, wherein said initial status report includes details surrounding an investigation conducted to understand facts giving rise to said litigation, such as a date, a synopsis of a case, facts giving rise to a cause of action, description of injuries or claimed damages or summary of an initial investigation.

10. The method according to claim 7, wherein said living theory of the case includes at least one of: a theory of a case, wherein said theory of said case may be continually re-evaluated and/or modified as said case proceeds, wherein said living theory of said case includes at least one of a date, a synopsis of said case, a living theory of said case, facts relating to a theory including supporting facts and inconsistent facts, and specific facts to be further investigated.

11. The method according to claim 7, wherein said litigation plan includes an analysis of at least one of:
review legal elements of each cause of action pled in said case;
identify facts/evidence that must be obtained in discovery in order to prove each required element;
identify witnesses who can provide a necessary foundation for said facts/evidence needed;
identify what facts/evidence will be disputed and identify witnesses and evidence to be used in putting those facts at issue;
evaluate evidentiary issues in order to maximize admissibility of proof; and
consider admissible evidence possessed by each party to determine both sides' strengths and weaknesses.

12. The method according to claim 11, wherein a template for said litigation plan includes at least one of: a date; a case title; a case number; a synopsis of a case; legal elements of claims, counterclaims, cross claims and/or affirmative defenses pled; identification of evidence and witnesses who will establish a foundation for said evidence; evidentiary considerations; description of a litigation strategy; litigation activities/tasks including estimated completion date; experts including a date to disclose opinion witnesses; anticipated outcome of identified activities; and current evaluation of liability, defenses and contribution.

13. The method according to claim 7, wherein settlement analysis includes at least one of: settlement recommendations, a history of settlement discussions, an analysis regarding mediation, arbitration or other means of alternative dispute resolution.

14. A method according to claim 7, wherein said Experts field includes at least one of: a Curriculum Vitae for potential experts, a narrative about potential experts, and fee information for each potential expert.

15. The method according to claim 7, wherein a template for an activity status report includes at least one of: a date; a synopsis of a case; identification of an activity, task or event; summary of significant information regarding an activity, task or event; effect on evaluation of a case; effect on a litigation plan, and additional work necessary in response to an activity, task or event.

16. The method according to claim 7, wherein said billing guidelines include at least one of: lawyers handling a matter, date of a service, time allocated to a service and a description of a service rendered.

17. The method according to claim 7, wherein said controls/metrics include at least one of: dates of objectives, tasks or events; status of a case; case outcome; performance of a lawyer; performance of a particular firm; results from a particular jurisdiction, or future expenses associated with a litigation.

18. The method according to claim 1, further comprising providing at least one quality control including at least one of: monitoring timely completion/posting of a draft answer or responsive pleading; substantive jury instructions; initial status report; living theory of a case; litigation plan; litigation budget; calculation of exposure in settlement; expert report; pleadings/motions; deadlines or due dates; monitoring a jury trial such as preparation of witnesses, sufficiency of motions, opening statement, ability to handle objections, direct examination, cross examination, sequence of witnesses, ability to handle demonstrative evidence, ability to lay a proper foundation, ability to communicate a theory of a case, closing argument, and/or interview with jurors; monitoring settlement issues including calculating settlement parameters, communicating settlement parameters, obtaining authority for settlement and timing of settlement; monitoring cost and efficiency of a litigation including budget versus actual legal expense, budget versus actual expense, number of times a law firm exceeds a budget, average verdict per law firm, average value of settlement per law firm, average cost for a discovery for all cases handled by a law firm, average cost of trial for all cases handled by a law firm, average number of depositions taken in a particular case, number of times a law firm requests an extension of time for responding to a motion, discovery request and/or trial; and various staffing matters.

19. The method of claim 1, further comprising providing digital, secure management of an entire litigation file which is accessible by a user at any time, world wide.

20. The method according to claim 1, wherein said information posted is immediately available for review by a user upon posting.

21. The method according to claim 3, wherein said website comprises at least one of field options including My Cases, My Calendar, Log In/Log Out, Alerts, Password Management and Administration,
wherein My Cases field includes all cases associated with a user and current Alerts,
wherein My Calendar field option enables a user to view a litigation calendar,
wherein Log In/Log Out field option enables a user to log into and out of said litigation management system,
wherein Alerts field option enables a user to view and manage various alerts relating to at least one lawsuit in a litigation portfolio,
wherein Password Management field option enables a user to change a password to said litigation management system,
wherein Administration field option provides a user with various administration options including one of client management, law firm management, user management, document attributes management and manage company locations.
